(19) United States
(12) Patent Application Publication
(10) Pub. No.: US 2003/0182428 A1
(43) Pub. Date: Sep. 25, 2003

(54) Peer-to-peer (P2P) communication system

(76) Inventors: Jiang Li, Beijing (CN); Keman Yu, Beijing (CN); Kaibo Wang, Xi'an (CN); Yong Li, Hangzhou (CN); Shipeng Li, Irvine, CA (US)

Correspondence Address: LEE & HAYES PLLC, 421 W RIVERSIDE AVENUE SUITE 500, SPOKANE, WA, 99201

(21) Appl. No.: 10/102,113

(22) Filed: Mar. 19, 2002

(51) Int. Cl. G06F 15/16

(52) U.S. Cl. 709/227

(57) ABSTRACT

Techniques are provided for use in establishing and maintaining a contacting/communication service and/or network that does not necessarily require the use of dedicated server devices. For example, improved methods and apparatuses are provided that can be used to provide peer-to-peer (P2P) or other like forms of communication in such a manner that users can remain aware of others' online/offline statuses, search for other users, conduct audio/video talk and chat with others, exchange information, and/or communicate in other ways with one another.

### TECHNICAL FIELD

This invention relates to computers and computer networks and more particularly to methods and apparatuses that provide a peer-to-peer (P2P) computer contacting architecture and communication system.

### BACKGROUND

One important goal of communication technology is to eventually enable people to exchange information from just about anywhere, at anytime, using a variety of devices. Currently, instant messaging services such as MSN Messenger, AOL Instant Messaging, ICQ and Yahoo Pager provide presence awareness and chat functionality to users of the Internet. Some of these messaging services also provide audio and video capabilities. However, the client/server architecture required by such services can make them unreliable at times. Peer-to-peer (P2P) computing architectures, which rely less upon dedicated servers, provide an alternative solution.

Various forms of P2P computing have been around for many years. Peerto-peer computing is basically the sharing of computer resources and services through the direct communication between the peer computer systems.

Traditionally, P2P computing allows peer computers to exchange files, processing cycles, cache storage, and/or disk storage. In such P2P architectures, the peer computers are configured to communicate directly between one another. As such, a peer computer may act as either a client device and/or a server device, depending on the computing process and also the needs of the resulting network of peer computers. The resulting P2P computing architecture tends to reduce the load placed on dedicated server devices, thereby freeing the server devices to perform other services. Furthermore, in certain traditional implementations, P2P computing often reduces the need for additional infrastructure resources to support certain services, such as, e.g., backup storage.

A recent popular form of P2P computing is exemplified by the file-sharing services provided by Napster, Gnutella, Freenet, Groove, and other like services/techniques. These file-sharing services allow peer computers to identify and share data files with other peer computers over the Internet. Napster, for example, utilizes a centralized directory service that is provided on one or more is dedicated server devices connected to the Internet. To search for and discover a file to download from another peer's computer, for example, a Napster peer computer acting as a client device to the dedicated server device and centralized directory service therein, is provided with a list of other Napster configured peer computers that have the particular file (e.g., an MP3 song, etc.) being requested. The requesting peer computer, acting as a client device, then connects directly with one of the identified other peer computers to access and download the requested file. Here, the other peer computer would then act as a server device to support the downloading process. Note that if the centralized directory service is unavailable for some reason, then the Napster service will not function properly.

Unlike Napster, Gnutella and other similar file-sharing services/techniques do not rely on a centralized directory service, and hence do not require dedicated server devices. Instead, files are basically searched for and discovered by having peer computers that directly communicate and pass queries from requesting peer computers to other neighboring peer computers. Upon receiving a query a Gnutella peer computer may, for example, decide to do nothing, respond back to the requesting peer computer (e.g., notifying the requester that the requested file has been found), or possibly forward the query on to one or more other peer computers, thus essentially continuing/widening the search for a given file. If the requested file is available for access and downloading from at least one of the other peer computers, then the requesting Gnutella peer computer, acting as a client device, can then connect to that peer computer and begin accessing/downloading the requested file. Here, again, the other peer computer would act as a server device during the accessing/downloading process.

Freenet is basically a P2P application that permits the publication, replication and/or retrieval of data files. It provides a mechanism designed to prevent both authors and readers of data from being detected by others. Thus, in other words, Freenet provides anonymity for users. To accomplish this, Freenet essentially creates what might be described as a very large and geographically distributed hard drive with anonymous access. When inserting a file, a Freenet node will distribute the encrypted file data in several other nodes and each node that saves the file data creates a routing item that is used in future requests for the file. After a successful insertion, the owner will publish a unique file description. A user who wants to retrieve the file only needs to input this file description. This retrieval message is then forwarded within the P2P network until a node that holds the request data returns it. Each node in the path for returning the requested data file also caches the data file in a local routing table. As such, the quality of the routing can be improved over time.

Groove is a system that provides shared spaces for users that need to collaborate on some project. With Groove, users make immediate and direct connections with other users. This results in a virtual space that is suitable for small group interactions. Such interactions may include communication media, tools for sharing, and other like activities. In each shared space, users can directly invite other users, add new tools, and keep track of the on-going activity and any changes that are made to the project(s). Groove is not a pure P2P system, since it requires a central directory server to find other users and then create connections to them. Groove also uses a relay service to keep synchronization for each user in a shared space.

Thus, it would be beneficial to have a contacting/communication service and/or network that does not necessarily require the use of dedicated server devices. Consequently, there is a need for improved methods and apparatuses that can be used to provide P2P contacting/communications services. Preferably, such P2P contacting/communication services will be capable of operating with and/or without the assistance of network servers. In certain implementations, for example, it would be useful if the resulting P2P communication service/network allows users to remain aware of others' online/offline statuses, search for other users, conduct audio/video talk and chat with others, and/or communicate in other ways with one another.

### SUMMARY

Techniques are provided for use in establishing and maintaining a contacting/communication service and/or network that does not necessarily require the use of dedicated server devices. For example, improved methods and apparatuses are provided that can be used to provide peer-to-peer (P2P) or other like forms of contacting/communication based on the users associated with the peer computers. In accordance with certain aspects of the present invention, the improved methods and apparatuses are capable of operating with or without the assistance of dedicated server devices. In accordance with certain implementations of the present invention, for example, the resulting P2P communication service/network allows users to remain aware of others' online/offline statuses, search for other users, conduct audio/video talk and chat with others, exchange information, and/or communicate in other ways with one another.

### BRIEF DESCRIPTION OF THE DRAWINGS

FIG. 1 is a block diagram of an exemplary computing device and computing environment, in accordance with certain implementations of the present invention.

FIG. 2A is a block diagram depicting an arrangement of peer computers, e.g., as in FIG. 1, that are operatively interconnected via one or more networks, in accordance with certain implementations of the present invention.

FIG. 2B is a flow diagram illustrating one way in which the peer computers of FIG. 2A may communicate with one another as part of a peer-to-peer (P2P) contacting/communication service/network, in accordance with certain implementations of the present invention.

FIG. 3 is an illustrative diagram depicting various services, functions and layers that may be implemented to provide a peer-to-peer (P2P) contacting/communication service/network, in accordance with certain implementations of the present invention.

FIG. 4 is an illustrative diagram showing a buddy user information that may be used in providing a peer-to-peer (P2P) contacting/communication service/network, in accordance with certain implementations of the present invention.

### DETAILED DESCRIPTION

Exemplary Computing Environment:

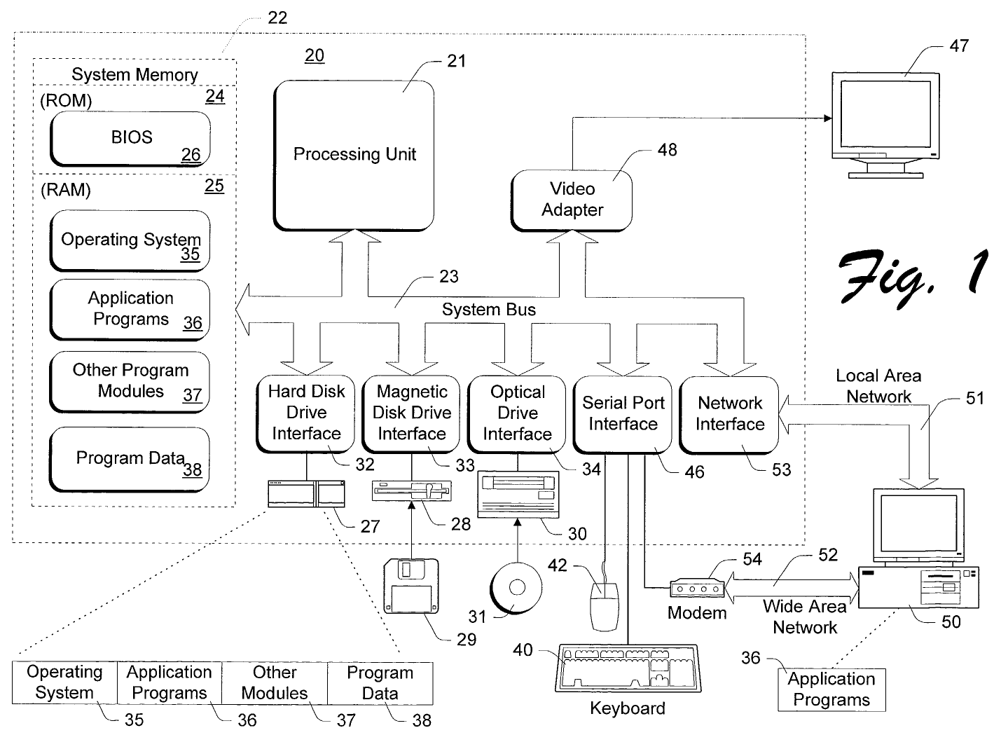

As shown in FIG. 1, computer 20 includes one or more processors or processing units 21, a system memory 22, and a bus 23 that couples various system components including the system memory 22 to processors 21. Bus 23 represents one or more of any of several types of bus structures, including a memory bus or memory controller, a peripheral bus, an accelerated graphics port, and a processor or local bus using any of a variety of bus architectures.

The system memory includes read only memory (ROM) 24 and random access memory (RAM) 25. A basic input/output system (BIOS) 26, containing the basic routines that help to transfer information between elements within computer 20, such as during start-up, is stored in ROM 24.

Computer 20 further includes a hard disk drive 27 for reading from and writing to a hard disk, not shown, a magnetic disk drive 28 for reading from and writing to a removable magnetic disk 29, and an optical disk drive 30 for reading from or writing to a removable optical disk 31 such as a CD ROM, DVD ROM or other optical media. The hard disk drive 27, magnetic disk drive 28 and optical disk drive 30 are each connected to bus 23 by applicable interfaces 32, 33 and 34, respectively.

The drives and their associated computer-readable media provide nonvolatile storage of computer readable instructions, data structures, program modules and other data for computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the exemplary operating environment.

A number of program modules may be stored on the hard disk, magnetic disk 29, optical disk 31, ROM 24, or RAM 25, including an operating system 35, one or more application programs 36, other program modules 37, and program 11 data 38. A user may enter commands and information into computer 20 through input devices such as keyboard 40 and pointing device 42. Other input devices (not shown) may include a microphone, joystick, game pad, satellite dish, scanner, or the like. These and other input devices are connected to the processing unit 21 through an interface 46 that is coupled to bus 23.

A monitor 47 or other type of display device is also connected to bus 23 via an interface, such as a video adapter 48. In addition to the monitor, personal computers typically include other peripheral output devices (not shown) such as speakers and printers.

Computer 20 can operate in a networked environment using logical connections to one or more remote computers, such as a remote computer 50. Remote computer 50 may be another personal computer, a server, a router, a network PC, a peer device or other common network node, and typically includes many or all of the elements described above relative to computer 20. The logical connections depicted in FIG. 1 include a local area network (LAN) 51 and a wide area network (WAN) 52. Such networking environments are commonplace in offices, enterprise-wide computer networks, intranets, and the Internet.

When used in a LAN networking environment, computer 20 is connected to the local network 51 through a network interface or adapter 53. When used in a WAN networking environment, computer 20 typically includes a modem 54 or other means for establishing communications over the wide area network 52, such as the Internet. Modem 54, which may be internal or external, is connected to bus 23 via interface 46. In a networked environment, program modules depicted relative to the personal computer 20, or portions thereof, may be stored in the remote memory storage device. It will be appreciated that the network connections shown are exemplary and other means of establishing a communications link between the computers may be used.

### Establishing An Exemplarv P2P Contacting/Communication

Service/Network:

The following description and associated figures are meant to illustrate certain methods and apparatuses that can be used to provide useful P2P features and benefits within a P2P or other like computing/communication environment. Those skilled in the art will recognize that the various methods and arrangements can be implemented and combined in a variety of ways to help form a P2P contacting and communicating service/network between peer computers with or without the use of dedicated server devices. Although FIG. 1 illustrates certain features associated with personal computers, it should be understood that other devices and/or arrangements may also be configured to act as a “peer computer” as used throughout this document. Thus, for example, a personal communication device, such as, e.g., a mobile telephone, a wireless handheld device or the like, may be configured to support applicable P2P communications.

It should also be clear that the various methods and apparatuses described herein can be implemented in a variety of ways within a particular peer computer. Thus, for example, certain methods may be implemented using logic. As used herein, the term “logic” includes, for example, computer software having computer implementable instructions, firmware, hardware, or any combination thereof. Further, the term logic as used herein is not intended to limit the implementation to a strictly logic structure, but is meant to include any applicable supporting structure as well. Thus, for example, a given block of logic within a block diagram or a method step may also include non-logic components/processes, such as, e.g., analog components, transceivers, data conversion components, etc.

Exemplary P2P Communication Network:

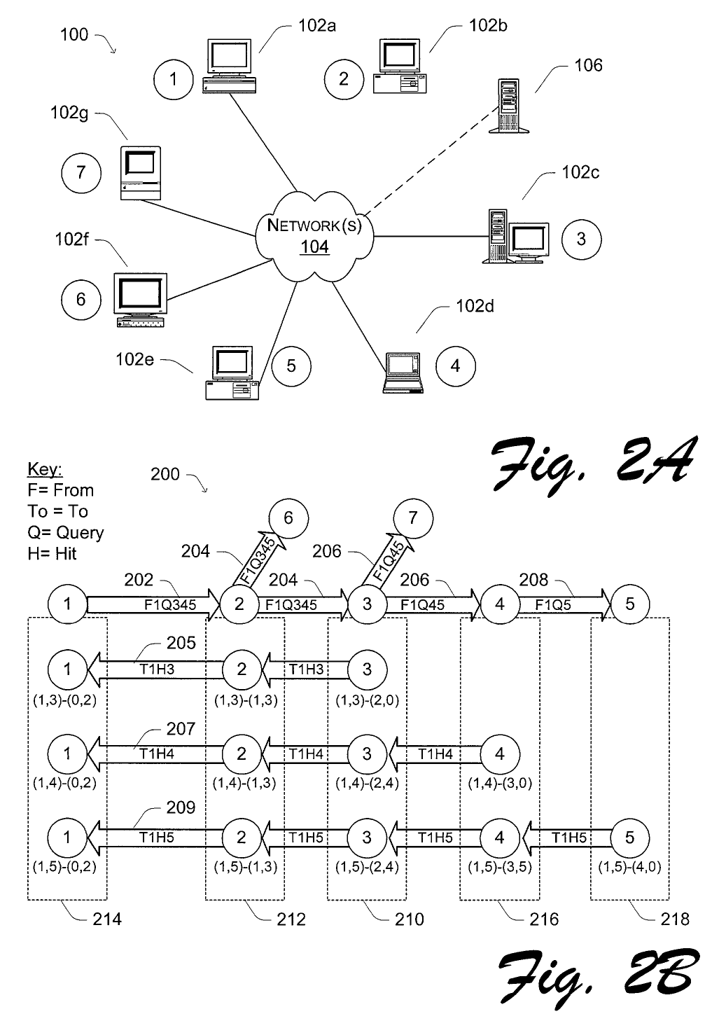

Reference is now made to FIG. 2A, which is a block diagram depicting an exemplary P2P network 100 of peer computers 102 of various types, one or more network(s) 104, and a (optional) dedicated server device 106. As illustrated, peer computers 102a-g are operatively connected to network(s) 104, as is server device 106. Network(s) 104 is representative of one or more communication links/channels. Thus, network(s) 104 may include, various wired and/or wireless communication resources and other computing resources that are configured to allow peer computers 102a-g to selectively connect to one another. In certain implementations, network(s) 104 includes a LAN, WAN, an intranet, the Internet, and/or other like networks.

As shown, associated with each of the peer computers 102a-g is a user represented by a circle with a numerical identifier. Here, user #1 is associated with peer computer 102a; user #2 is associated with peer computer 102b; user #3 is associated with peer computer 102c; user #4 is associated with peer computer 102d; user #5 is associated with peer computer 102e; user #6 is associated with peer computer 102f; and, user #7 is associated with peer computer 102g. These users are shown again and referred to below with regard to the exemplary P2P communication process illustrated in FIG. 2B.

Identification Of A Peer Computer (User):

The P2P methods and apparatuses herein benefit by having each peer computer 102 (i.e., each user) identified by a unique or at least substantially unique identifier. Herein, the identifier will be simply referred to as a universally unique identifier (UUID). The WUID, which is associated with a user, may be provided to the peer computer or generated by the peer computer itself For example, peer computer 102a can generate a UUID for a user #1 when he/she logs on, or peer computer 102a may have the user provide his/her UUID or otherwise identify or perhaps import a file that records his/her UUID. This provided information may also include other information, such as, personal information about the user (e.g., name, address, telephone number, etc.) and the user's “buddy list” information. The buddy user information is described in greater detail in subsequent sections.

In certain preferred implementations, the UUID that is supplied is actually encrypted in some manner or otherwise protected. Thus, the user would then be required to input a password or provide other forms of proof (e.g., perhaps a smart card, token, etc.) that allows the supplied UUID to be decrypted or otherwise processed. Any other information provided may also be so encrypted/protected.

The UUID is configured to uniquely identify the user, such that each user of a peer computer 102 will have a different and unique identifier. Thus, the resulting identifier will usually need to be sufficiently large enough to make the chances that two users would have the same UUID very rare if not impossible. It is possible that UUIDs could be assigned by a central authority, such as, e.g., a service on dedicated server device 106. This would insure that each UUID is indeed unique to its user. However, if a P2P network is to be created without the use of a dedicated server device, then the UUID will need to be generated locally. Various known techniques are available for generating such identifiers. One exemplary way to generate a substantially unique identifier is to provide cryptographic or similar logic that generates a significantly long enough identifier based on user provided identifying information (e.g., name, address, telephone number, electronic mail address, user name/password combinations, or other like personal data) and/or machine unique information (e.g., serial numbers, processor numbers, software registration numbers, etc.).

In accordance with certain aspects of the present invention, it is preferred that each user be able to export his/her UUID, other personal information and buddy user information to other peer computers that the user may become associated with. Thus, for example, a file may be generated with such information, perhaps with all or part of the information encrypted or otherwise encoded in some manner to protect the information from unauthorized access/use.

The resulting UUID is then used within the P2P service/network to identify the user. The peer computer 102 that a user is actually using can further be uniquely identified by the unique network address it is assigned (e.g., IP address, or the like). The P2P network is configured by selectively linking peer computers 102 together based on the UUID, peer computer address information and/or other information such as that provided in the buddy user information.

Joining A P2P Communication Service/Network:

A new user may join a P2P communication service/network using different methods. By way of example, the new user may: (1) input the network address (e.g., an IP address) of a user that is already part of the P2P communication network; (2) input the Internet Locator Service (ILS) servers associated with a user at who is already in the P2P communication network; and/or, (3) input other IDs associated with a user already in the P2P communication network or other instant messaging service, such as, e.g., the user's IDs in MSN Messenger Service, AOL Instant Messaging, ICQ, or Yahoo Pager.

The underlying purpose for these exemplary joining methods is for the new user to somehow learn or otherwise provide the network address (e.g., IP address) of an existing P2P communication network user, and to then initiate or send a connection request to that user's peer computer 102. This connection request is an attempt to establish a buddy relation between the existing user and the new user seeking to join the P2P communication network.

When the existing user's peer computer receives the connection request from new user seeking to join the P2P communication network, the request can either be accepted or rejected. If the request is accepted, then the existing and new users exchange UUIDs and possibly other personal information. Each user maintains buddy user information. Upon receipt, the exchanged information is added to the buddy user information (e.g., a buddy list may be updated to include the buddy user's current information).

As described in the sections that follow, the buddy user information maintained by each P2P communication network participating user is used to direct communications between peer computers 102.

An Exemplary Query Process:

Once a user has joined the P2P communication network, each time the user logons or otherwise initiates the P2P communication service/network, the peer computer 102 uses the last recorded network addresses (e.g. IP addresses) from the buddy user information in an attempt to connect with each user buddy user's peer computer. If a connection attempt fails, then the peer computer 102 can be further configured to try to connect to the buddy user's peer computer based on their recorded ID and ILS servers, and/or other instant messaging services (provided any required dedicated server devices are present).

In the meantime, the peer computer 102 is also configured to send a query message (e.g., query packets) to those buddy users that have been successfully connected to. For example, an initial query message might seek a buddy user from the buddy user information that has yet to be located/connected. Upon receipt of the query message, each of the connected buddy users' peer computers process and, if applicable, forward the query message to one or more other currently connected buddy users. If the “lost” buddy user is eventually located, then the acquired route information associated with the buddy user and the buddy user's network address (e.g., IP address), for example, is sent back to the user who initiated the query. This returning message is referred to as a hit response message. Interconnecting peer computers can also make use of the acquired route information from the hit response message.

Upon receipt of a hit response message, the peer computer 102 can then use the newly acquired network address, which it records in its buddy user information, to directly connect to the “found” buddy user's peer computer 102. If the attempt to directly connect to the “found” buddy user's peer computer 102 fails, then future information/messages can instead be sent through an indirect approach via the acquired route information brought back by the hit response message.

An example of a query process 200 is illustrated in FIG. 2B. For simplification purposes, rather than referring to specific peer computers, references are instead made to specific numbered users and buddy users that are assumed to be operating the peer computers in accord with the examples in FIG. 2A. Here, the P2P communication network/service includes (at least) users #1 though #7 per FIG. 2A. The respectively numbered circles once again represent these various users.

In this example, it is assumed that user #1 has recently joined the P2P communication network and seeks to locate buddy users #3, #4 and #5, each of whom have previously joined the P2P communication network. Here, however, the existing buddy user information maintained by user #1 no longer includes the correct network addresses for buddy users #3, #4 and #5. User #1 does have the correct network address for buddy user #2 in his/her buddy user information. Thus, user #1 can successfully connect to buddy user #2 directly.

Notice further, that in this example, it is assumed that further direct connections have already been established: (a) between user #2 and users #3 and #6; (b) between user #3 and users #4 and #7; and, (c) between user #4 and user #5.

Recall that user #1 wants to, if at all possible, once again locate buddy users #3, #4 and #5. To do so, user #1 will send one or more query messages to one or more of its connected buddy users. Thus, in this small example, user #1 sends a query message 202 to user #2. The query message 202 notation in FIG. 2B reads “F1Q345”, which (in accordance with the key shown in FIG. 2B) translates to “From user #1: querying users #3, #4 and #5”. Thus, query message 202 is basically looking for user #1's “lost” buddy users #3, #4 and #5.

Upon receipt of query message 202, user #2 not being queried itself by message 202 then forwards the query on in query message 204 to connected buddy users #3 and #6.

Upon receipt of query message 204, user #6 not being queried itself by message 204 does nothing more with the query since in this example it has no other connected buddy users.

User #3, on the other hand, is being queried by message 204. Thus, upon receipt of query message 204, user #3 sends a hit response message 205 back to user #2. User #2 then sends hit response message 205 back to user #1. The hit response message 205 notation in FIG. 2B reads “T1H3”, which (in accordance with the key shown in FIG. 2B) translates to “To user #1: hit user #3”. Here, hit response message 205 may include identifying information about user #3, e.g., address of peer computer, UUID, etc.

Along its way from user #3 to user #1, hit response message 205 allows the interconnecting user(s) to record acquired route information, which might be needed in the future to correctly route other messages between user #1 and user #3. This route information is described in greater detail below.

Also upon receipt of query message 204, user #3 forwards the remaining query on in query message 206 to connected buddy users #4 and #7. Here, query message 206 is “F1Q45”, and is thusly continuing the query for the remaining missing buddy users #4 and #5 on behalf of user #1.

Upon receipt of query message 206, user #7 not being queried itself by message 206 does nothing more with the query since in this example it has no other connected buddy users.

User #4, being queried itself by message 206, sends a hit response message 207 back to user #3. User #3 then sends hit response message 207 back to user #2, and subsequently user #2 then sends hit response message 207 back to user #1. The hit response message 207 notation in FIG. 2B reads “T1H4”, which (in accordance with the key shown in FIG. 2B) translates to “To user #1: hit user #4”. Along its way from user #4 to user #1, hit response message 207 allows the interconnecting user(s) to record acquired route information, which might be needed in the future to correctly route other messages between user #1 and user #4. Also upon receipt of query message 206, user #4 forwards the remaining query on in query message 208 to connected buddy user #5. Here, query message 208 is “F1Q5”, and is thusly continuing the query for the one remaining missing buddy user #5, again on behalf of user #1.

Now, user #5, being queried itself by message 208, sends a hit response message 209 back to user #4. Then, user #4 then sends hit response message 209 back to user #3, who then sends hit response message 209 back to user #2, who then sends it back to user #1. The hit response message 209 notation in FIG. 2B reads “T1H5”, which translates to “To user #1: hit user #5”. Along its way from user #5 to user #1, hit response message 209 also allows the interconnecting user(s) to record acquired route information, which might be needed in the future to correctly route other messages between user #1 and user #4.

Thus, in this example, user #1 has been able to locate all of the his/her buddy users (here, users #2 through #5) with the assistance of various interconnecting users.

In addition to being terminated in end nodes such as users #6 and #7, a query message may also be terminated for other reasons along the way. For example, a query message may be terminated after it has been passed on to buddy users a predefined number of times. Thus, for example, a time-to-live (TTL) value can be assigned to a message/packet when the query is created, each time the query passes through a buddy user node, and then the TTL value can be altered in some manner. If a later user node detects that the TTL value has expired (e.g., reached a certain value), then the query will not be continued.

As mentioned, the returning hit response messages allow the interconnecting user nodes to record route information. This is illustrated, for example, in FIG. 2B by notations as follows:

(PS, PR)-(SID, RID)

where,

PS: the packet sender, here, the number of the user who sends the packet;

PR: the packet receiver, here, the number of the user who receives the packet that is sent by the above user;

SID: the physical connection ID on the sender's side of the current user, i.e., in this example, the number of the user who can provide a path to the sender for the current user. Note that the path may be direct, or indirect (routed).

RID: the physical connection ID on the receiver's side of the current user, i.e., in this example, the number of the user who can provide a path to the packet receiver for the current user. Again, the path may be direct or indirect (routed).

If the SID or RID equals zero, it means that the packet has already reached the user node.

For example, user #3 stores an item in its route information 210 that reads “(1, 5)-(2, 4)”. This means that for a packet that is sent from user #1 to user #5 and passes through the current user-user #3, the message/packet is delivered to the current user-user #3 via user #2 and sent to the receiver-user #5 via user #4. For another example, user #4 stores an item in its route information 216 that reads “(1, 4)-(3, 0)”. This item illustrates that for a message/packet that is sent from user #1 to user #4, it is delivered to the current user-user #4 via user #3. Obviously, this route information is reversible. For the first example, “(1, 5)-(2, 4)” also means for a message/packet that is sent from user #5 to user #1 and passes through the current user-user #3, the packet is delivered to the current user-user #3 via user #4, and sent to the receiver-user #1 via user #2.

FIG. 2B only shows the stored route information after user #1 queried for buddy users #2, #3, #4, and #5. Route information 214 is associated with user #1, route information 212 is associated with user #2, and route information 218 is associated with user #5.

The above acquired route information can be dynamically maintained and subsequently used to quickly route messages/packets within the resulting P2P communication network. For example, next time, if user #3 receives a packet from user #2, which is sent originally from user #1 and whose destination is user #5, then user #3 need not query users #4 and #7 again. Instead user #3 need only simply deliver it to user #4. User #4 will also know that the packet should be delivered to user #5 according to the route information “(1, 5)-(3, 0)” that was previously stored.

The store of the route information associated with each user node is also helpfuil in the adjustment of the record if some user nodes fail (e.g., crash). For example, if user #4 crashes, the connection between user #4 and user #3, and the connection between user #4 and user #5 will be broken. As user #3 knows that user #4 is unavailable, the route information “(1, 4)-(2, 4)” and “(1, 5)-(2, 4)” can be deleted (i.e., updated). The route information “(1, 4)-(1, 3)” and “(1, 5) (1, 3)” in 212 (for user #2), which depends on the route information of user #3, will also be deleted, and so on.

In accordance with certain implementations of the present invention, the actual recorded route information takes this format, wherein the user nodes are represented by the UUID.

Searching For Users:

In accordance with certain aspects of the present invention, the P2P communication network/serves described herein can be further configured to allow users to search for a person using criteria such as first name, last name, etc., by including such items in the information that is sent to connected buddy users. The receiving buddy users may then compare (or otherwise process) the search criteria against their buddy user information to see if they can find the “lost” buddy user for the querying user. The connected buddy users may also send such information or a subset thereof on to other connected buddy users to further the search for the “lost” buddy user. As before, information regarding any hits to the search is sent back to the initiating user.

Overview Of An Exemplary P2P Communication System Model:

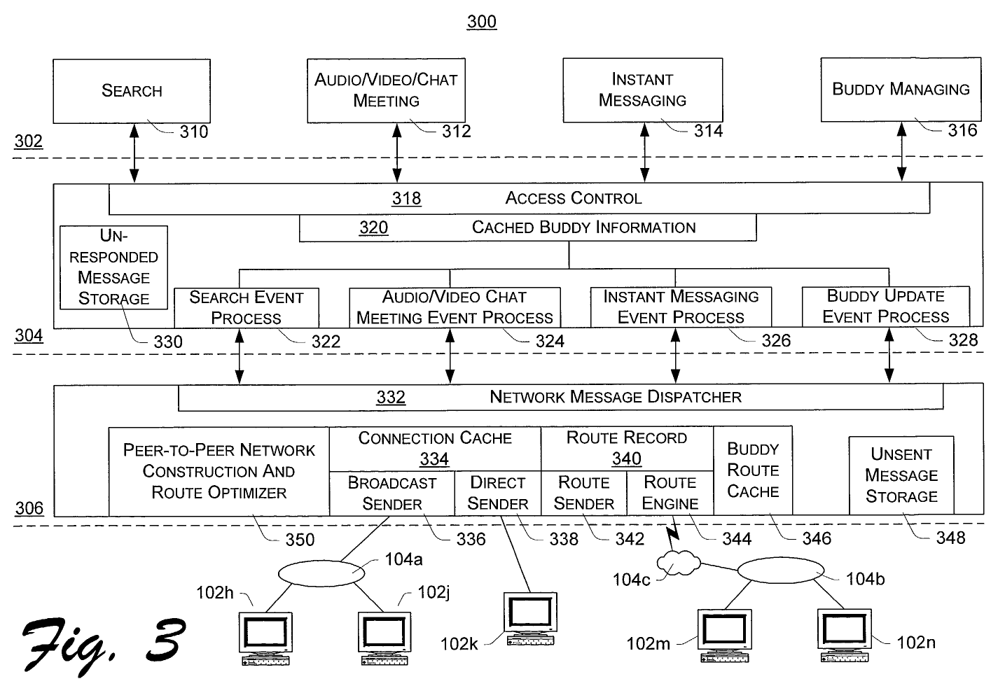

With the above exemplary P2P communication network/services in mind, attention is now drawn to FIG. 3, which is a block diagram depicting an exemplary P2P communication system model 300 all or part of which can be implemented, for example, through logic provided in a peer computer 102, to provide an effective P2P communication network/services in accordance with certain aspects of the present invention.

System model 300 includes three basic layers, namely, a user interface layer 302, a function logic layer 304 and a P2P network layer 306. These layers may, for example, be implemented at the ISO model's application layer in software operating in a peer computer 102.

P2P network layer 306, which should not be confused with a ISO model “network layer”, is essentially configured to perform network related tasks, such as, e.g., P2P network construction, protocol pre-processing, route table managing, message forwarding, and the like. Thus, P2P network layer 306 basically provides the networking communications that may be referred to as the “P2P engine” portion of P2P communication system model 300.

User interface layer 302 is configured to provide any necessary interaction with the user. Thus, for example, user interface layer 302 may be configured to provide a graphical user interface (GUI) and/or accept user inputs, such as, e.g., logon information, personal information, WUID related information, buddy user information, search requests/criteria, etc. User interface layer 302 preferably allows a user to manage his/her buddy user information. User interface layer 302 may also be configured to launch or otherwise provide an applicable meeting interface capability, for example, audio, video, chat, and/or instant messaging capabilities/functions may be required for a particular online “meeting” between P2P network/services users.

Function logic layer 304, which is depicted in between user interface layer 302 and P2P network layer 306, is configured to perform a variety of tasks, and/or provide a variety of functions. Basically, however, function logic layer 304 is arranged to deliver messages and information between user interface layer 302 and P2P network layer 306. Thus, function logic layer 304 may, for example, be configured to dispatch query messages, search messages, meeting control messages, and/or instant messaging service messages.

To accomplish these and other tasks, function logic layer 304 includes, for example, a search event process module 322, a meeting event process module 324, an instant messaging event process module 326, and a buddy update event process module 328.

With this overview in mind, the various capabilities/functions in each of the three layers in the exemplary P2P communication system model will now be described in greater detail. Those skilled in the art will, nevertheless recognize that this is just one example of how a peer computer 102 may be configured or programmed to become part of a P2P communication network/service using existing network resources.

User Interface Layer 302:

User interface layer 302 includes a search module 310 that is configured to support user initiated searching for new and/or known buddy users. In this example, search module 310 is configured to solicit and accept user inputs that define the search criteria. Thus, for example, the search criteria may include information about the buddy user to be located, such as, e.g., first name, last name, email address, etc. All or part of this information is eventually output by search module 310 and provided to search event process module 322 in function logic layer 304 for further processing.

Audio/video/chat meeting module 312 is configured to provide an applicable meeting interface for the user of peer computer 102. Thus, by way of example, a user may initiate and/or attend multiple different meetings. The user may invite his/her buddy users to join in and participate in, or otherwise attend a video, audio and/or chat-based meeting. Here, in this example, the user may selectively choose to turn on/off his/her own or another attendee's video and/or voice outputs. The resulting audio/video/chat data is eventually output by audio/video/chat meeting module 312 is eventually provided to and processed by the audio/video/chat meeting event process module 324 in function logic layer 304.

An instant messaging module 314 is also provided in user interface layer 302. Instant messaging module 314 is configured to allow the user to send/receive instant messages to a particular buddy. In certain preferred implementations, instant messaging module 314 allows such instant messages to be sent in such a way that that other buddy users that are perhaps attending an ongoing meeting(s) do not know or learn of the instant messages being sent. In this example, instant messaging module 314 is thusly, configured to allow the user to select a buddy user and then input and initiate an instant messaging capability in which to exchange messages. The data of instant messaging is eventually provided to and processed by an instant messaging event process module 326 in function logic layer 304.

A buddy managing module 316 is configured within user interface layer 302 to allow a user to add, delete, update, and/or otherwise modify buddy user interface information associated with the user. All of part of the information collected/output by buddy managing module 316 is eventually provided to a buddy update event process module 328 in function logic layer 304.

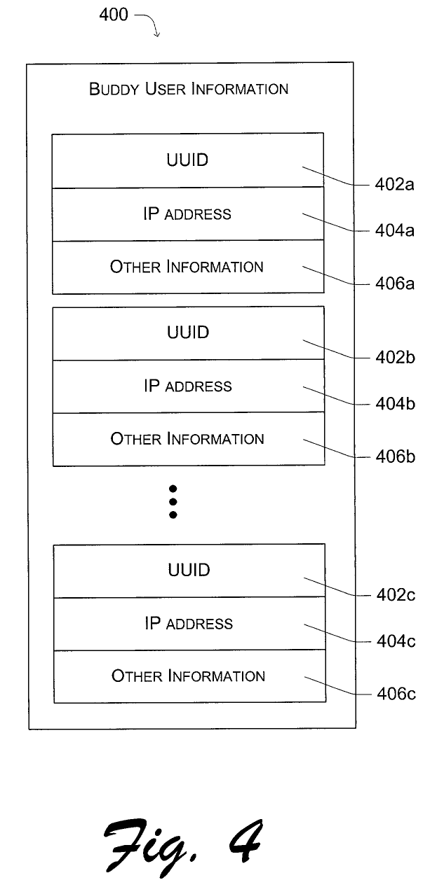

Reference is now made to FIG. 4, which is an illustrative diagram showing exemplary representative buddy user information 400 that includes buddy user information for one or more buddy users. Here, in this example, a first buddy user is identified by buddy user information that includes a WUID 402a, a network address 404a, and/or other information 406a. Other information 406a may include, for example, a buddy user's name, address, telephone number, electronic mail address, ILS, and/or any other type of information that may be helpful in identifying and/or locating the buddy user through the P2P network/service. Also shown in FIG. 4, a UUID 402b, a network address 404b, and/or other information 406b may be stored for a second buddy user. Similarly, another buddy user may have his/her identifying information provided through UUID 402c, network address 404c, and/or other information 406c.

Function Logic Layer 304:

Returning now to the example in FIG. 3, function logic layer 304 includes an un-responded message storage module 330. Suppose, for example, that a user requests to add a new buddy user, but that buddy user is currently offline. If a server device 106 were connected to network 104 (see, FIG. 2A), then a request message to the new buddy user can be stored by server device 106 and provided to the buddy user when he/she comes online again. However, if the P2P communication network/service does not have an available server device, then the delayed sending task needs to be performed by the applicable peer computer 102 itself. One difference between un-responded message storage module 330 and unsent message storage module 348 is that un-responded message storage module 330 is configured to store information for buddy users that are known to currently be offline and required to make responses.

Search event process module 322 is configured to convert user input or otherwise identified search criteria into data formatted for delivery through the P2P network/service.

An audio/video/chat meeting event process module 324 is also provided in function logic layer 304. In this example, audio/video/chat meeting event process module 324 is configured to process audio/video/chat information and deliver such information between user interface layer 302 and P2P network layer 306. For example, when a user attends several meetings at the same time, his/her audio/video/chat data will be sent to each attendee of these meetings. In certain cases, some attendees may be present at multiple meetings, so audio/video/chat meeting event process module 324 is preferably configured to manage the sending (and receiving) of the audio/video/chat information of the user to ensure that only one copy of the audio/video/chat information is sent to the various applicable meeting attendees. Audio/video/chat meeting event process module 324 may also be configured to control the turning on/off of each attendee's audio/video/chat information and/or the user's audio/video/chat information.

An instant message event process module 326 is included in function logic layer 304. This module is configured to process instant messages and deliver such messages between user interface layer 302 and P2P network layer 304.

A buddy update event process module 328 is provided and configured to initiate at least one thread to repeatedly detect buddy users' online/offline status. Thus, preferably this module is also configured to organize and send query information out through P2P network layer 306, as needed. In this manner, this module essentially detects that a buddy has changed his/her status, the results/updates are then provided to buddy managing module 316 in user interface layer 302, wherein, for example, the received information is used to update the displayed buddy user status within a GUI.

Function logic layer 304 also includes an access control module 318, which is configured to operate in the background and distribute inputs/tasks from the various modules in user interface layer 302 to appropriate modules within function logic layer 304. For example, access control module 318 can be configured to insure that information from search module 310 is provided to search event process module 322. With regard to audio/video/chat meetings, for example, access control module 318 can be configured to further insure that the information is sent only to the actual attendees and/or a select subset thereof.

Finally, function logic layer 304 includes a cached buddy information module 320, which is configured to temporarily store buddy user information for those users that are not part of the normal buddy user information, but are nevertheless attendees of an ongoing audio/video/chat meeting that is being conducted over the P2P network/service. Once the meeting has ended, the cached buddy user information is no longer needed and hence it can be erased.

P2P Network Layer 304:

P2P network layer 304 includes a P2P network construction and route optimization module 350. This module is configured to support/perform operations such as the query process illustrated in FIG. 2B. Through the joining and query processes described above and ongoing P2P network/service operations, P2P network construction and route optimization module 350 is able to build and maintain routing information, such as, for example, routing information 214 (see FIG. 2B). Preferably, P2P network construction and route optimization module 350 includes logic that enables the routing of messages/packets to be substantially optimized. Thus, for example, P2P network construction and route optimization is module 350 may be configured to analyze the current routing information and look for more direct communication paths through the P2P communication network. Preferably, however, each buddy user will be communicated with via a direct connection. Where this is not possible, then usually it would be preferred to have the messages/packets relayed over the fastest interconnecting P2P structure. P2P network construction and route optimization module 350 may therefore evaluate paths based on latency, etc., and perhaps seek to initiate new/different paths to buddy users if the initially acquired path imparts too great of latency on the communication messages/packets.

Several modules will now be described, which are called senders or otherwise identified as being involved in sending messages/packets. It should be kept in mind, however, that these modules may also be configured to support both the sending and receiving of information.

A broadcast sender module 336 is provided in P2P network layer 304. This module is configured to broadcast the query and search requests, audio/video/chat data and/or instant messages to a network 104a (e.g., a LAN), assuming that the peer computer 102h is connected to network 104a (as shown). Since many networks support multicast messages, broadcast sender module 336 can be configured to broadcast query and search requests in a manner that takes advantage of multicasting without causing undue network congestion. Note that if a buddy user is using peer computer 102j, which is also connected to network 104a, then peer computer 102j will respond to applicable multicast or otherwise broadcast query/search request messages.

A direct sender module 338 is also provided within P2P network layer 306. This module is configured to send query and search request messages, audio/video/chat data, and/or instant messages to a specified buddy user at his/her network address (e.g., IP address) once it is known. Here, for example, a buddy user at peer computer 102k may be communicated with directly by the direct sender module 338.

P2P network layer 306 further includes a route sender module 342, which is configured to send query and search request messages, audio/video/chat data, and/or instant messages via routes, e.g., according to the acquired route stored in the user's routing information. In this manner, the sent information will be delivered one by one along the connected buddy users, as illustrated in the example of FIG. 2B.

A route engine module 344 is provided in P2P network layer 306 and configured to maintain the routing information and help deliver the information via various routes. For example, information may be sent and received from buddy users at peer computers 102m and 102n, which are connected to a network 104b that is further connected to a network 104c. Here, network 104c includes a wireless link to route engine 344, for example.

A buddy route cache module 346 is provided in P2P network layer 306. This module is configured to temporarily store information relating to other meeting attendees' access information. Such meeting attendees may be considered as temporal buddy users. When the meeting ends, this information is no longer needed and thus no longer maintained.

An unsent message storage module 348 is also provided in P2P network layer 306. Unsent message storage module 348 is configured to persist/store any unsent information including, for example, query and search request messages, instant messages, etc. Suppose, for example, that a user sends an instant message to another user, but that the intended recipient user just happened to go offline at about the same time that the instant message was sent. Hence, the user has sent out the message, but the intended recipient user does not receive it. This is where unsent message storage module 348 acts to keep a copy of the unsent message for later retransmission.

P2P network layer includes a network message dispatcher module 332, which is configured to coordinate/control the communication of information between function logic layer 304 and P2P network layer 306.

In this example, P2P network layer 306 also includes a connection cache module 334, which is basically configured to provide storage of that are messages sent/received by broadcast sender module 336 and direct sender module 338

Finally, P2P network layer 306 includes a route record module 340, which is basically configured to record applicable routing information that is used by route sender module 342 and route engine module 344.

Although some preferred implementations of the various methods and arrangements of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

1. A method for establishing a peer-to-peer (P2P) computing service between a plurality of peer computers that are operatively coupled through at least one network, the method comprising:
causing a first peer computer, being used by a first user, to send a query message over said network to at least one other peer computer, said query message including information identifying a buddy user; and
causing a second peer computer, being used by said identified buddy user, to send a hit response message over said network in response to receiving said query message, said hit response message including identifying information about said second peer computer.

2. The method as recited in claim 1, wherein causing said first peer computer to send said query message further includes:
causing said first computer to send said query message to at least one computer address stored in buddy user information maintained by said first peer computer and associated with said identified buddy user.

3. The method as recited in claim 1, wherein causing said first peer computer to send said query message further includes:
causing said first computer to send said query message to at least one computer address stored in buddy user information maintained by said first peer computer and associated with at least one other buddy user.

4. The method as recited in claim 3, wherein said at least one computer address stored in said buddy user information associated with said at least one other buddy user is for a third peer computer, the method further comprising:
causing said third peer computer, being used by said at least one other buddy user, to send said query message over said network to said second computer as result of on said identified buddy user also being included in buddy user information maintained by said third peer computer.

5. The method as recited in claim 4, further comprising:
causing said second peer computer to send said hit response message over said network to said third peer computer in response to receiving said query message from said third peer computer; and
in response to receiving said hit response message from said second peer computer, causing said third peer computer to send said hit response message over said network to said first peer computer.

6. The method as recited in claim 5, further comprising:
in response to receiving said hit response message from said second peer computer, causing said third peer computer to update routing information maintained by said third peer computer based on said hit response message.

7. The method as recited in claim 5, further comprising:
in response to receiving said hit response message from said third peer computer, causing said first peer computer to update routing information maintained by said first peer computer based on said hit response message.

8. The method as recited in claim 1, wherein said identifying information in said hit response message includes a computer address associated with said second peer computer.

9. The method as recited in claim 8, wherein said computer address associated with said second peer computer includes a network address.

10. The method as recited in claim 9, wherein said network address includes an Internet Protocol (IP) address.

11. The method as recited in claim 8, further comprising:
subsequently causing said first peer computer to connect directly with said second peer computer based on said computer address received in said hit response message.

12. The method as recited in claim 11, wherein causing said first peer computer to connect directly with said second peer computer based on said computer address further includes:
causing said first peer computer to update routing information maintained by said first peer computer so as to associate said identified buddy user with said computer address.

13. The method as recited in claim 1, wherein said information identifying said buddy user in said query message includes a substantially universally unique identifier (UUID) associated with said buddy user.

14. The method as recited in claim 1, further comprising:
subsequently causing said first peer computer to conduct a search process for a fourth user by sending a search message to said second peer computer; and
in response to said search message, causing said second peer computer to compare search criteria in said received search message with buddy user information maintained by said second peer computer.

15. The method as recited in claim 1, further comprising:
subsequently causing said first peer computer and said second peer computer to conduct an online meeting between said first user and said identified buddy user.

16. The method as recited in claim 15, wherein said online meeting includes the exchange of at least one form of data selected from a group of data comprising audio data, video data, and text data.

17. The method as recited in claim 1, further comprising:
subsequently causing said first peer computer and said second peer computer to exchange instant messaging messages.

18. A computer readable medium having computer implementable instructions for performing acts comprising:
establishing a peer-to-peer (P2P) computing service between a plurality of peer computers that are operatively coupled through at least one network, by:
causing a first peer computer, being used by a first user, to send a query message over said network to at least one other peer computer, said query message including information identifying a buddy user; and
causing a second peer computer, being used by said identified buddy user, to send a hit response message over said network in response to receiving said query message, said hit response message including identifying information about said second peer computer.

19. The computer readable medium as recited in claim 18, wherein causing said first peer computer to send said query message further includes:
causing said first computer to send said query message to at least one computer address stored in buddy user information maintained by said first peer computer and associated with said identified buddy user.

20. The computer readable medium as recited in claim 18, wherein causing said first peer computer to send said query message further includes:
causing said first computer to send said query message to at least one computer address stored in buddy user information maintained by said first peer computer and associated with at least one other buddy user.

21. The computer readable medium as recited in claim 20, wherein said at least one computer address stored in said buddy user information associated with said at least one other buddy user is for a third peer computer, and further comprising computer implementable instructions for performing acts comprising:
causing said third peer computer, being used by said at least one other buddy user, to send said query message over said network to said second computer as result of on said identified buddy user also being included in buddy user information maintained by said third peer computer.

22. The computer readable medium as recited in claim 21, further comprising:
causing said second peer computer to send said hit response message over said network to said third peer computer in response to receiving said query message from said third peer computer; and
is response to receiving said hit response message from said second peer computer, causing said third peer computer to send said hit response message over said network to said first peer computer.

23. The computer readable medium as recited in claim 22, further comprising:
in response to receiving said hit response message from said second peer computer, causing said third peer computer to update routing information maintained by said third peer computer based on said hit response message.

24. The computer readable medium as recited in claim 22, having further computer implementable instructions for performing acts comprising:
in response to receiving said hit response message from said third peer computer, causing said first peer computer to update routing information maintained by said first peer computer based on said hit response message.

25. The computer readable medium as recited in claim 18, wherein said identifying information in said hit response message includes a computer address associated with said second peer computer.

26. The computer readable medium as recited in claim 25, wherein said computer address associated with said second peer computer includes a network address.

27. The computer readable medium as recited in claim 26, wherein said network address includes an Internet Protocol (IP) address.

28. The computer readable medium as recited in claim 25, having further computer implementable instructions for performing acts comprising:
subsequently causing said first peer computer to connect directly with said second peer computer based on said computer address received in said hit response message.

29. The computer readable medium as recited in claim 28, wherein causing said first peer computer to connect directly with said second peer computer based on said computer address further includes:
causing said first peer computer to update routing information maintained by said first peer computer so as to associate said identified buddy user with said computer address.

30. The computer readable medium as recited in claim 29, wherein causing said first peer computer to update routing information maintained by said first peer computer based on said hit response message.

31. The computer readable medium as recited in claim 18, wherein said information identifying said buddy user in said query message includes a substantially universally unique identifier (UUID) associated with said buddy user.

32. The computer readable medium as recited in claim 18, having further computer implementable instructions for performing acts comprising:
subsequently causing said first peer computer to conduct a search process for a fourth user by sending a search message to said second peer computer; and
in response to said search message, causing said second peer computer to compare search criteria in said received search message with buddy user information maintained by said second peer computer.

33. The computer readable medium as recited in claim 18, having further computer implementable instructions for performing acts comprising:
subsequently causing said first peer computer and said second peer computer to conduct an online meeting between said first user and said identified buddy user.

34. The computer readable medium as recited in claim 33, wherein said online meeting includes the exchange of at least one form of data selected from a group of data comprising audio data, video data, and text data.

35. The computer readable medium as recited in claim 18, having further computer implementable instructions for performing acts comprising:
subsequently causing said first peer computer and said second peer computer to exchange instant messaging messages.

36. A method for use in a peer computer that is configurable to connect to at least one other peer computer to form a peer-to-peer (P2P) network, the method comprising:
establishing buddy user information associated with a current user of said peer computer, said buddy user information including identifying information about at least one buddy user; and
causing said peer computer to prepare a query message based on said identifying information about said buddy user, said query message being suitable for transmission over at least one network to at least one other peer computer as identified in said buddy user information.

37. The method as recited in claim 36, further comprising:
causing said peer computer to send said query message to said at least one other peer computer.

38. The method as recited in claim 37, wherein causing said peer computer to send said query message to said at least one other peer computer further includes:
causing said peer computer to send said query message to a computer address stored in said buddy user information.

39. The method as recited in claim 37, wherein causing said peer computer to send said query message to said at least one other peer computer further includes:
causing said peer computer to send said query message to at least one computer address that is stored in said buddy user information and associated with at least one other buddy user.

40. The method as recited in claim 37, further comprising:
with said peer computer, receiving a hit response message from at least one peer computer in response to said query message; and
causing said peer computer to update routing information associated with said buddy user based on identifying information in said received hit response message.

41. The method as recited in claim 40, wherein said identifying information in said hit response message includes a computer address associated with said a peer computer currently being used by said buddy user.

42. The method as recited in claim 41, wherein said computer address of said peer computer currently being used by said buddy user includes a network address.

43. The method as recited in claim 42, wherein said network address includes an Internet Protocol (IP) address.

44. The method as recited in claim 40, further comprising:
subsequently causing said peer computer to connect directly with said peer computer currently being used by said buddy user based on said computer address received in said hit response message.

45. The method as recited in claim 36, wherein said information identifying said buddy user in said query message includes a substantially universally unique identifier (UUID) associated with said buddy user.

46. A computer readable medium having computer implementable instructions for performing acts comprising:
configuring a peer computer to connect to at least one other peer computer to form a peer-to-peer (P2P) network, by:
establishing buddy user information associated with a current user of said peer computer, said buddy user information including identifying information about at least one buddy user; and
causing said peer computer to prepare a query message based on said identifying information about said buddy user, said query message being suitable for transmission over at least one network to at least one other peer computer as identified in said buddy user information.

47. The computer readable medium as recited in claim 46, having further computer implementable instructions for performing acts comprising:
causing said peer computer to send said query message to said at least one other peer computer.

48. The computer readable medium as recited in claim 47, wherein causing said peer computer to send said query message to said at least one other peer computer further includes:
causing said peer computer to send said query message to a computer address stored in said buddy user information.

49. The computer readable medium as recited in claim 47, wherein causing said peer computer to send said query message to said at least one other peer computer further includes:
causing said peer computer to send said query message to at least one computer address that is stored in said buddy user information and associated with at least one other buddy user.

50. The computer readable medium as recited in claim 47, having further computer implementable instructions for performing acts comprising:
with said peer computer, receiving a hit response message from at least one peer computer in response to said query message; and
causing said peer computer to update routing information associated with said buddy user based on identifying information in said received hit response message.

51. The computer readable medium as recited in claim 50, wherein said identifying information in said hit response message includes a computer address associated with said a peer computer currently being used by said buddy user.

52. The computer readable medium as recited in claim 51, wherein said computer address of said peer computer currently being used by said buddy user includes a network address.

53. The computer readable medium as recited in claim 52, wherein said network address includes an Internet Protocol (IP) address.

54. The computer readable medium as recited in claim 50, having further computer implementable instructions for performing acts comprising:
subsequently causing said peer computer to connect directly with said peer computer currently being used by said buddy user based on said computer address received in said hit response message.

55. The computer readable medium as recited in claim 46, wherein said information identifying said buddy user in said query message includes a substantially universally unique identifier (UUID) associated with said buddy user.

56. A system comprising:
a plurality of peer computers operatively interconnected through at least one network and arranged to form a peer-to peer (P2P) network that includes at least:
a first peer computer associated with a first user, said first peer computer being configured to send a query message over said at least one network to at least one other peer computer, said query message including information identifying a buddy user, and
a second peer computer associated with said identified buddy user, said second peer computer begin configured to send a hit response message back to said first peer computer over said at least one network in response to receiving said query message, said hit response message including identifying information about said second peer computer.

57. The system as recited in claim 56, wherein said first peer computer is further configured to send said query message to at least one computer address stored in buddy user information maintained by said first peer computer and associated with said identified buddy user.

58. The system as recited in claim 56, wherein said first peer computer is further configured to send said query message to at least one computer address stored in buddy user information maintained by said first peer computer and associated with at least one other buddy user.

59. The system as recited in claim 58, further comprising:
a third peer computer associated with at least one other buddy user, and wherein said at least one computer address stored in said buddy user information associated with said at least one other buddy user is for a third peer computer, and wherein said third peer computer is configured to send said query message over said network to said second computer as result of on said identified buddy user also being included in buddy user information maintained by said third peer computer.

60. The system as recited in claim 59, wherein said second peer computer is further configured to send said hit response message over said network to said third peer computer in response to receiving said query message from said third peer computer; and
wherein, in response to receiving said hit response message from said second peer computer, said third peer computer is further configured to send said hit response message over said network to said first peer computer.

61. The system as recited in claim 60, wherein, in response to receiving said hit response message from said second peer computer, said third peer computer is further configured to update routing information maintained by said third peer computer based on said hit response message.

62. The system as recited in claim 60, wherein, in response to receiving said hit response message from said third peer computer, said first peer computer is further configured to update routing information maintained by said first peer computer based on said hit response message.

63. The system as recited in claim 56, wherein said identifying information in said hit response message includes a computer address associated with said second peer computer.

64. The system as recited in claim 63, wherein said computer address associated with said second peer computer includes a network address.

65. The system as recited in claim 64, wherein said network address includes an Internet Protocol (IP) address.

66. The system as recited in claim 63, wherein said first peer computer is further configured to connect directly with said second peer computer based on said computer address received in said hit response message.

67. The system as recited in claim 66, wherein said first peer computer is further configured to update routing information maintained by said first peer computer so as to associate said identified buddy user with said computer address.

68. The system as recited in claim 56, wherein said information identifying said buddy user in said query message includes a substantially universally unique identifier (WUID) associated with said buddy user.

69. The system as recited in claim 56, wherein said first peer computer is further configured to conduct a search process for a fourth user by sending a search message to said second peer computer; and
in response to said search message, said second peer computer is configured to compare search criteria in said received search message with buddy user information maintained by said second peer computer.

70. The system as recited in claim 56, wherein said first peer computer and said second peer computer are configured to conduct an online meeting between said first user and said identified buddy user.

71. The system as recited in claim 70, wherein said online meeting includes the exchange of at least one form of data selected from a group of data comprising audio data, video data, and text data.

72. The system as recited in claim 56, wherein said first peer computer and said second peer computer are configured to exchange instant messaging messages.
